(19) United States
(12) Patent Application Publication
(10) Pub. No.: US 2021/0037082 A1
(43) Pub. Date: Feb. 4, 2021

(54) METHOD OF SENDING MEDIA FILES

(71) Applicant: RONG-DER HONG, Taichung City (TW)

(72) Inventors: RONG-DER HONG, Taichung City (TW); CHIEN-HUNG LEE, Taichung City (TW)

(73) Assignee: RONG-DER HONG, Taichung City (TW)

(21) Appl. No.: 16/527,667

(22) Filed: Jul. 31, 2019

(51) Int. Cl. H04L 29/08; G06F 16/48; G06F 16/41

(52) U.S. Cl. CPC H04L 67/06; G06F 16/41; G06F 16/48

(57) ABSTRACT

A method of sending media files is provided, which includes the following steps. The first user reads an identification code on an electronic tag by the first electronic device, and transmits the media file, the identification code, and the first identification datum to the server by the first electronic device. The server generates a recorded data set including a link information for the media file. After getting the electronic tag, the second user reads the identification code of the electronic tag, and transmits the identification code and the second identification datum to the server by the second electronic device so as to compare with the recorded data set. If they are consistent, the server sends the link information for the media file to the second electronic device so that the second electronic device obtains the media file accordingly, and thus to increase information security for sending media files.

### BACKGROUND OF THE INVENTION

### 1. Technical Field

The present invention relates generally to sending electronic data, and more particularly to a method of sending media files.

### 2. Description of Related Art

With the advancement of technology, network technology has flourished, and information transmission has also become more and more convenient. Through a variety of communication software, users can send media files such as video files and voice files to other users at will for sharing information.

However, for a media file to be shared with a specific user, a password is usually added to the media file which are then encapsulated into a compressed file (e.g., ZIP file and RAR file). Next, the encrypted compressed file is transmitted to the specific user, and the password for decrypting is provided to the specific user as well. After receiving and open the compressed file from an electronic device, the user enters the password to decompress and restore the compressed file to the original media file so as to play the media file on the electronic device.

In the above, although the compressed file can provide encryption protection for the media file, there is still a decryption software which can decrypt the compressed file. Therefore, the third party can decrypt the compressed file with the decryption software to obtain the media file without the password, and even post the media file on the Internet, so that others can download it, which results in the leak of privacy.

### BRIEF SUMMARY OF THE INVENTION

In view of the above, the primary objective of the present invention is to provide a method of sending media files which improves information security for sending media files.

The present invention provides a method of sending media files, which includes the following steps.

A. a first user obtains an identification code which is provide on and corresponding to an electronic tag by a first electronic device, and enters a first identification datum into the first electronic device, as well as selects a media file; the first electronic device transmits the identification code, the first identification datum, and the media file to a server;

B. the server stores the media file and generates a recorded data set, wherein the recorded data set includes the identification code, the first identification datum, and a link information for the media file;

C. a second user obtains the identification code which is provide on and corresponding to an electronic tag by a second electronic device, and enters a second identification datum into the second electronic device; the second electronic device transmits the identification code and the second identification datum to the server; and

D. the server compares the identification code and the second identification datum transmitted from the second electronic device with the identification code and the first identification datum in the recorded data set, and if they are consistent, sends the link information for media file to the second electronic device; the second electronic device obtains the media file according to the received link information.

The effect of the present invention is, the second user can obtain the media file only if the electronic tag is consistent with the second identification datum, which increases information security for obtaining media files. Even getting the electronic tag, the third party is unable to obtain the media file easily.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of the data management system and the connection structure thereof, to which the first preferred embodiment of the present invention is applied;

FIG. 2 is a flow chart of the first preferred embodiment of the present invention;

FIG. 3 is a schematic diagram of the content of the database of the first preferred embodiment of the present invention;

FIG. 4 is a flow chart of another part of the first preferred embodiment of the present invention besides the part in FIG. 2; and

FIG. 5 is a flow chart of the second preferred embodiment of the present invention.

### DETAILED DESCRIPTION OF THE INVENTION

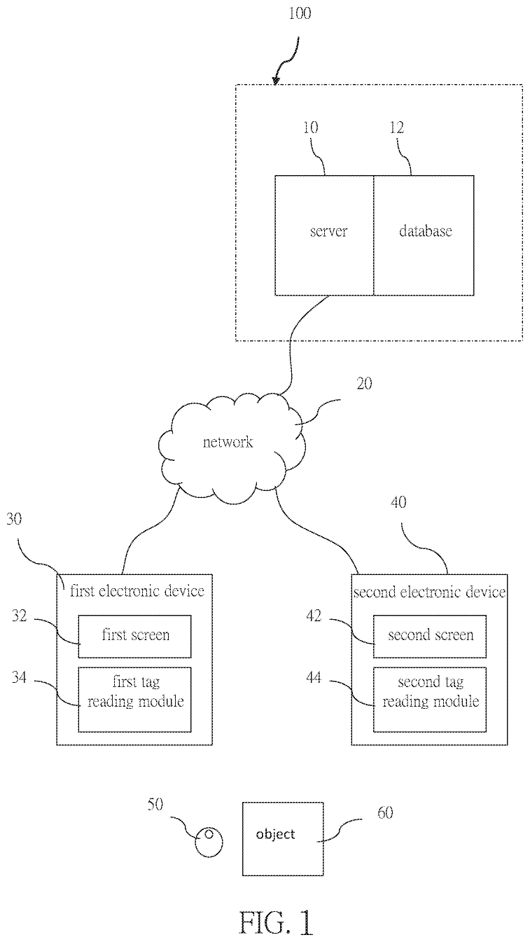

As shown in FIG. 1, a data management system 100 and the connection structure thereof, to which the first preferred embodiment of the present invention is applied, are illustrated. The data management system 100 includes a server 10 and a database 12, wherein the server 10 is connected to the database 12. The server 10 is connected to a network 20 in a wired or wireless manner. The server 10 is provided to process the data in the database 12, and to store data in the database 12. The database 12 shown in FIG. 1 of the first embodiment is independent of the server 10. However, this is not a limitation on the present invention. In other words, the database 12 and the server 10 could be integrated into a host.

A first electronic device 30 and a second electronic device 40 are respectively connected to the server 10 through the network 20. The first electronic device 30 and the second electronic device 40 could be computers, smart phones, or tablets, which are networkable equipment connected through the network in a wired or wireless manner.

The electronic device 30 is held by a first user, and the second electronic device 40 is held by a second user. The electronic device 30 has a first screen 32 and a first tag reading module 34, wherein the first screen 32 is provided for displaying data. The first tag reading device 34 is provided for reading at least an electronic tag 50 in a contactless manner so as to obtain an identification code which is contained in and corresponding to the electronic tag 50. The electronic tag 50 can be, for example, an RFID tag. The at least an electronic tag 50 can be used independently or with at least an object 60. For example, the at least an electronic tag 50 can be provided on or beside the at least an object 60. In practice, there can be a plurality of electronic tags 50, and the electronic tags 50 can be used with a plurality of objects 60 respectively. The first tag reading module 34 can read a single or multiple electronic tags 50 at a time. The second electronic device 40 has a second screen 42 and a second tag reading module 44, and the functions thereof are the same as the ones of the first electronic device 30 mentioned above.

The aforementioned object 60 can be any article such as equipment and gift.

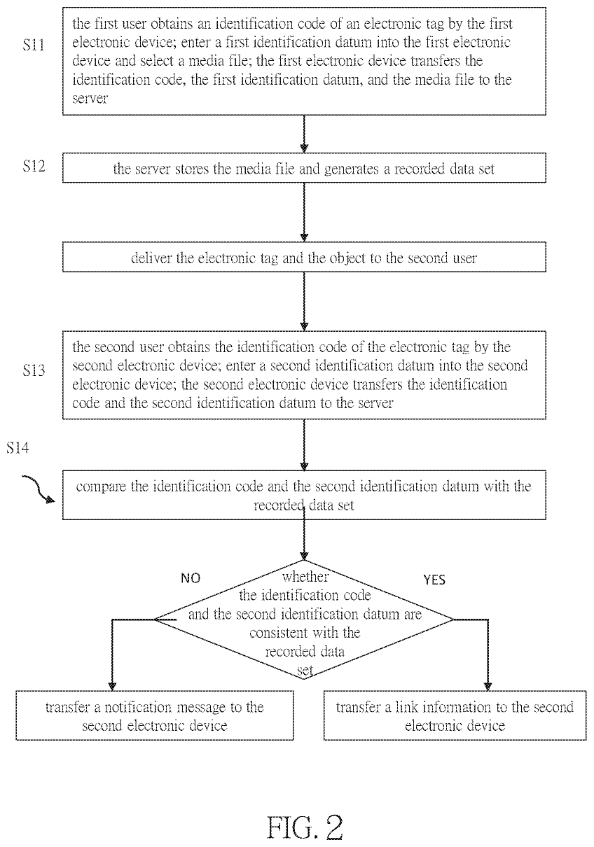

By the above structure, a method of sending media files in this embodiment includes the following steps shown in FIG. 2.

Step S11: the first user obtains an identification code which is provided on and corresponding to the electronic tag 50 through the first electronic device 30, and enters a first identification datum into the first electronic device 30, and selects a media file. The first electronic device 30 transmits the identification code, the first identification datum, and the media file to the server 10.

In this embodiment, a user operates the first electronic device 30 and runs an application to read the electronic tag 50 with the first tag reading module 34. Thus, the electronic device 30 can obtain the identification code and store it. Practically, the identification code can be manually entered into the first electronic device 30 by the first user. For example, the identification code of the electronic tag 50 is printed on paper or the electronic tag, and the first user manually enters the identification code after viewing it.

In this step S11, the first user operates the first electronic device 30 to record video with a camera module (not shown) to create the media file. Next, the first user enters the first identification datum into the first electronic device 30 as well as selects the recorded media file.

The abovementioned first identification datum in this embodiment is an account, i.e., the account of the second user such as the account of the second user on the server, or the second user's account for communication, e.g., e-mail, Line, and WeChat. In practice, the first identification datum can be the second user's phone number.

The method of inputting the account can be directly mutual entering, or obtaining by connecting the first electronic device 30 with the server. For example, a plurality of user accounts are recorded in the server 10 previously, and after the first electronic device 30 is connected to the server 10 as well as logged in with the account of the first user, the server 10 transmits the other accounts to the first electronic device 30. Accordingly, the first user selects one of the accounts (i.e., the account of the second user) through the first electronic device 30.

Afterward, the first electronic device 30 transmits the identification code, the first identification datum, and the media file to the server 10 through the network 20. Moreover, the first electronic device 30 can also transmit the first user's account to the server 10.

Besides video files, the media files can be voice files or multimedia files. Take voice files as an example, users can create the files with a recording module (not shown) of the first electronic device 30.

In addition to recording the media files directly, users can select the present media files in the first electronic device 30.

Step S12: the server 10 stores the media file, and generates a recorded data set, wherein the recorded data set includes the identification code, the first identification datum, and a link information for the media file.

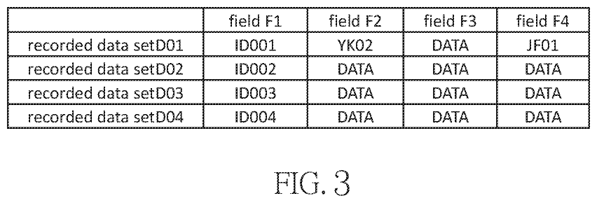

In this embodiment, after receiving the media file, the server 10 stores the media file in the database 12, and generates the recorded data set D01 as shown in FIG. 3 as well as stores it in the database. The recorded data set includes a plurality of fields, wherein the identification code “ID001” is recorded in field F1; the first identification datum “YK02” is recorded in field F2; the link information for the media file is recorded in field F3, which is represented as “DATA”. Furthermore, if the server 10 receives the account of the first user, the first user's account “JF01” is then recorded in field F4.

The server 10 generates a web address for the stored media file according to the media file, and uses the web address as the link information.

In this embodiment, the database 12 further includes a plurality of recorded data sets D02 to D04 which are respectively corresponding to the different identification codes “ID002” to “ID004”. Additionally, the content in fields F2 to F4 of the recorded data sets D02 to D04 is represented as “DATA”.

Afterward, the first user transfers the electronic tag 50 along with the object 60 to the second user; if the electronic tag 50 is used independently, the first user transfers the electronic tag 50 to the second user.

Step S13: the second user obtains the identification code which is provided on and corresponding to the electronic tag 50 by the second electronic device 40, and enters a second identification datum into the second electronic device 40. The second electronic device 40 transmits the identification code and the second identification datum to the server 10.

In this embodiment, after receiving the electronic tag 50 and the object 60, the second user operates the second electronic device 40 and runs an application to start the second tag reading module 44 thereof. Therefore, the second electronic device 40 can read the electronic tag 50 to obtain the identification code and to store it. The second identification datum entered by the second user in the second electronic device 40 is an account (i.e., the account used to login the server 10 by the second user). Afterward, the second electronic device 40 transmits the identification code and the second identification datum to the server 10 through the network 20. The second identification datum can be the second user's account for communication, e.g., e-mail, Line, and WeChat, or the second user's phone number.

Step S14: the server 10 compares the identification code and the second identification datum transmitted from the second electronic device 40 with the identification code and the first identification datum in the recorded data set D01; if the identification code and the second identification datum transmitted from the second electronic device 40 are consistent with the identification code and the first identification datum in the recorded data set D01, the server 10 sends the link information for the media file to the second electronic device 40. The second electronic device 40 then obtains the media file according to the received link information.

For example, the identification code transmitted from the second electronic device 40 is “ID001”, and the second identification datum is “YK02”. The server 10 compares the identification code “ID001” with the recorded data sets D01 to D04 in the database 12 so as to find the corresponding recorded data set D01. Furthermore, after confirming the second identification datum “YK02” is consistent with the content “YK02” in field F2 of the recorded data set D01, the server 10 then sends the link information in field F3 to the second electronic device 40.

Thus, the second electronic device 40 obtains the media file according to the link information so as to play the file by displaying on the second screen 42, and/or by playing the sound through a loudspeaker (not shown) of the second electronic device 40. Accordingly, the second user will know the content of the media file that the first user wants to convey.

For example, the media file can be a film or voice file which introduces the object 60 or for operation instructions, in addition, the media file can also be a film or voice file with a message that the first user wants to communicate to the second user.

Most importantly, the second identification datum has to be compared with the first identification datum, which increases information security for obtaining media files. Even getting the electronic tag 50, the third party is unable to obtain the media file easily.

Besides the aforementioned steps, Step S14 of this embodiment further includes the following steps for improving information security.

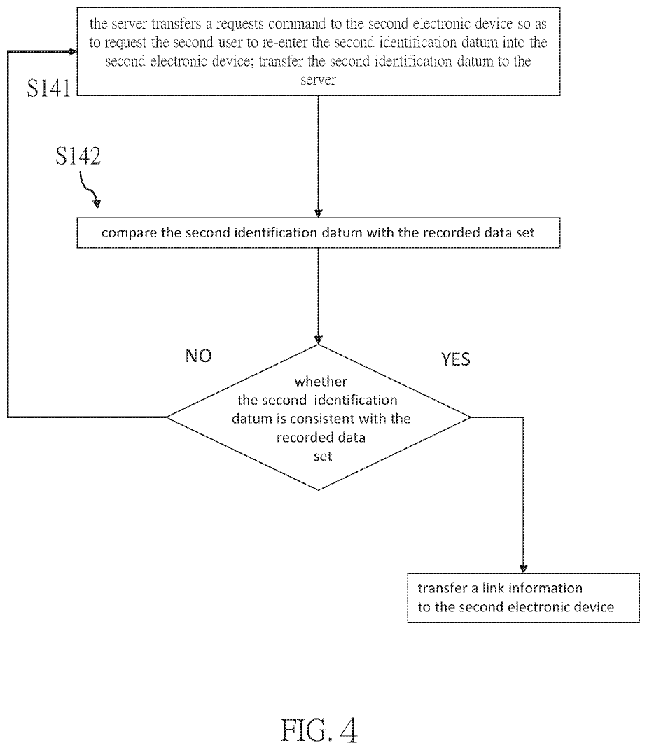

After the server 10 compares the second identification datum transmitted from the second electronic device 40 with the first identification datum in the recorded data set D01, if the second identification datum is different from the first identification datum, the server 10 transmits a notification message to the second electronic device 40 so as to inform users that the second identification datum entered by the second user is incorrect, which is followed by the steps illustrated in FIG. 4.

Step S141: the server 10 transmits a requests command to the second electronic device 40 so as to request the second user to re-enter the second identification datum into the second electronic device 40, and then the second electronic device 40 transmits the second identification datum to the server 10.

Step S142: the server 10 compares the second identification datum with the first identification datum in the recorded data set D01 again; if the two identification datum are consistent, send the link information for the media file to the second electronic device 40, while if they are different, re-performs the previous step S141.

The above step S141 can further includes the step of requesting the second electronic device 40 to obtain the identification code of the electronic tag 50 again, and transfer the identification code to the server 10. Moreover, step S141 can also include the step of comparing the identification code with the identification code of the recorded data set D01 again.

Besides, in step S142, if the second identification datum has been compared with and different from the first identification datum for many times in a row, the server 10 would terminate the access authority of the recorded data set D01 so that the second electronic device 40 is unable to obtain the media file. After terminating the access authority of the recorded data set D01, the server 10 transmits a notification message to the first electronic device 30 so as to inform the first user that the media file cannot be sent to the second electronic device 40.

By the aforementioned steps S141 to S142, the security of the sending method of the media files in this embodiment is further increased.

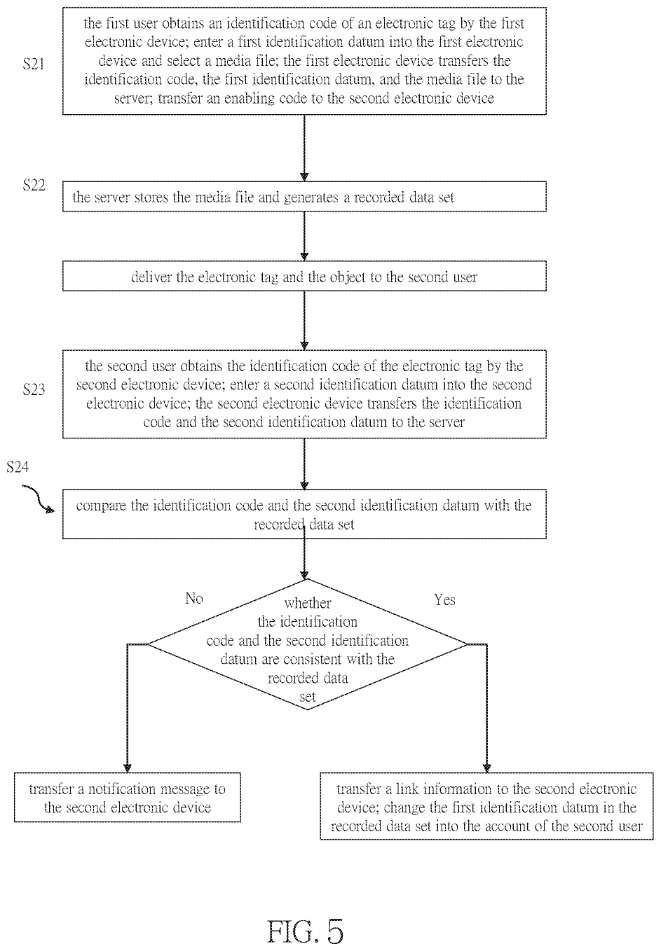

As shown in FIG. 5, in the second embodiment, steps S21 to S24 are roughly the same as the ones in the first embodiment. The difference is, in step S21, the first identification datum can be an enabling code. For example, in the situation that the first user has no idea of the second user's account, the first identification datum is the enabling code, wherein the enabling code can be entered into the first electronic device 30 by the first user personally, or generated by the first electronic device 30 itself. In any step before step S23 (take step S21 as an example), the first user transmits the enabling code to the second electronic device 40 from the first electronic device 30.

In step S23, the second user can thus enter the second identification datum which includes the second user's account and the enabling code into the second electronic device 40.

In step S24, if the server 10 compares the enabling code of the second identification datum with the first identification datum as well as confirms they are consistent, the server 10 not only sends the link information to the second electronic device 40 but also changes the first identification datum in the recorded data set D01 into the account of the second user.

Afterward, the server 10 transmits the changed first identification datum (i.e., the second user's account) to first electronic device 30. Therefore, the first user can send the media file to the second user as well as know the account of the second user.

Thereafter, as long as the second user reads the electronic tag 50 with the second electronic device 40, and enters the second user's account, and additionally, the server 10 confirms the second user's account and the recorded data set D01 are consistent, the second electronic device 40 can obtain the link information for the media file.

The embodiments described above are only preferred embodiments of the present invention. All equivalent methods which employ the concepts disclosed in this specification and the appended claims should fall within the scope of the present invention.

1. A method of sending media files, which comprises the steps of:
A. obtaining an identification code which is provided on and corresponding to an electronic tag by a first electronic device, and entering a first identification datum into the first electronic device, as well as selecting a media file, which are performed by a first user; transmitting the identification code, the first identification datum, and the media file to a server, which is performed by the first electronic device;
B. storing the media file and generating a recorded data set, which are performed by the server, wherein the recorded data set comprises the identification code, the first identification datum, and a link information for the media file;
C. obtaining the identification code which is provided on and corresponding to the electronic tag by a second electronic device, and entering a second identification datum into the second electronic device, which are performed by a second user; transmitting the identification code and the second identification datum to the server, which is performed by the second electronic device; and
D. comparing the identification code and the second identification datum which are transmitted from the second electronic device with the identification code and the first identification datum in the recorded data set, which is performed by the server; if the identification code and the second identification datum which are transmitted from the second electronic device are consistent with the identification code and the first identification datum in the recorded data set, sending the link information for the media file to the second electronic device, which is performed by the server; obtaining the media file according to the received link information, which is performed by the second electronic device;
wherein the first identification datum is an enabling code, and a way that the second user obtains the enabling code is different from a way that the second user obtains the identification code.

2. The method of claim 1, wherein the server generates a web address for the media file according to the stored media file; the web address constitutes the link information.

3. The method of claim 1, wherein step D further comprises the step of transmitting a notification message to the second electronic device if the second identification datum transmitted from the second electronic device and the first identification datum in the recorded data set are different, which is performed by the server.

4. The method of claim 1, wherein in step D, if the second identification datum transmitted from the second electronic device and the first identification datum in the recorded data set are different, step D further comprises the steps of:
step D1: transmitting a requests command to the second electronic device so as to request the second user to re-enter the second identification datum into the second electronic device, which is performed by the server; transmitting the re-entered second identification datum to the server, which is performed by the second electronic device; and
step D2: after comparing the second identification datum with the first identification datum in the recorded data set, if the second identification datum is consistent with the first identification datum in the recorded data set, sending the link information for the media file to the second electronic device, which is performed by the server.

5. The method of claim 4, wherein in step D2, if the second identification datum is different from the first identification datum in the recorded data set, re-perform the previous step D1.

6. The method of claim 5, wherein in step D2, if the second identification datum has been compared with and different from the first identification datum for many times in a row, terminating an access authority of the recorded data set, which is performed by the server.

7. The method of claim 6, further comprising the step of transmitting a notification message to the first electronic device after terminating the access authority of the recorded data set, which is performed by the server.

8. (canceled)

9. The method of claim 1, wherein before step C, the first electronic device transmits the enabling code to the second electronic device; in step C, the second identification datum comprises an account and the enabling code; in step D, after comparing the enabling code in the second identification datum with the first identification datum, if the enabling code is consistent with the first identification datum, the server changes the first identification datum in the recorded data set into the account.

10. The method of claim 9, further comprising the step of transmitting the changed first identification datum to the first electronic device after step D, which is performed by the server.

11. A method of sending media files, which comprises the steps of:
A. obtaining an identification code which is provided on and corresponding to an electronic tag by a first electronic device, and entering a first identification datum into the first electronic device, as well as selecting a media file, which are performed by a first user; transmitting the identification code, the first identification datum, and the media file to a server, which is performed by the first electronic device;
B. storing the media file and generating a recorded data set, which are performed by the server, wherein the recorded data set comprises the identification code, the first identification datum, and a link information for the media file;
C. obtaining the identification code which is provided on and corresponding to the electronic tag by a second electronic device, and entering a second identification datum into the second electronic device, which are performed by a second user; transmitting the identification code and the second identification datum to the server, which is performed by the second electronic device; and
D. comparing the identification code and the second identification datum which are transmitted from the second electronic device with the identification code and the first identification datum in the recorded data set, which is performed by the server; if the identification code and the second identification datum which are transmitted from the second electronic device are consistent with the identification code and the first identification datum in the recorded data set, sending the link information for the media file to the second electronic device, which is performed by the server; obtaining the media file according to the received link information, which is performed by the second electronic device;
wherein in step A, the first identification datum is an enabling code; before step C, the first electronic device transmits the enabling code to the second electronic device; in step C, the second identification datum comprises an account and the enabling code; in step D, after comparing the enabling code in the second identification datum with the first identification datum, if the enabling code is consistent with the first identification datum, the server changes the first identification datum in the recorded data set into the account.
